(19) United States
(12) Patent Application Publication
(10) Pub. No.: US 2026/0348511 A1
(43) Pub. Date: Nov. 5, 2026

(54) LOAD BALANCING DEVICE FOR HEADS FOR FILM AND TELEVISION SHOOTS

(71) Applicant: CARTONI S.P.A, Roma (IT)

(72) Inventor: Alessandro FIORE, Roma (IT)

(73) Assignee: CARTONI S.P.A, Roma, RM (IT)

(21) Appl. No.: 19/195,137

(22) Filed: Apr. 30, 2025

(30) Foreign Application Priority Data
May 2, 2024 (IT) 102024000009889

(51) Int. Cl. F16M 11/16; F16M 11/08

(52) U.S. Cl. CPC F16M 11/16; F16M 11/08

(57) ABSTRACT

The present invention concerns a device (100) for supporting and balancing the load of cameras for film and/or television shoots, said device (100) comprising a main structure (7) and a fixing plate (5) for supporting the camera. Said fixing plate (5) is constrained in a centre of rotation (O₁) on said main structure (7) to perform a rotation with respect to a vertical axis (y) of a shooting angle (θ) between −90° and +90°. Said device (100) further comprises at least one first connecting rod element (2) having a first end (A₂) pivoted to said fixing plate (5) at a first eccentric distance (O₁A₂) from said centre of rotation (O₁), a rocker arm element (3) having a first hinge (3′) associated with the second end (B₂) of said first connecting rod (2) and a second hinge (3″) pivoted and coupled to said main structure (7), and at least one elastic element (4), pivoted at the top to said main structure (7) and slidably coupled at the bottom to said rocker arm element (3). Said device (100) is characterised in that it further comprises a second connecting rod (2′) having a first end (A₂′) pivoted to said fixing plate (5) at a second eccentric distance (O₁A₂′) from said centre of rotation (O₁) and a second end (B₂′) associated with said first hinge (3′) of said rocker arm element (3), in that each connecting rod (2; 2′) provides an oblong slot (20; 20′) having at least one bend at its second end (B₂; B₂′), in that said device (100) is configured in such a way that, when said shooting angle (θ) is equal to 0°, the eccentric distance (O₁A₂) of the first connecting rod (2) is oriented with respect to said vertical axis (y) by an offset angle (φ) greater than 0° and the eccentric distance (O₁A₂′) of the second connecting rod (2′) is oriented with respect to said vertical axis (y) by an offset angle (φ′) less than 0° and in such a way that the first hinge (3′) of said rocker arm element (3) is pivoted in said bend of the oblong slot (20, 20′) of each connecting rod (2, 2′), and in that said device (100) is configured in such a way that, when said shooting angle (θ) is greater than 0°, said first hinge (3′) of said rocker arm element (3) is pivoted only in the bend of the slot (20) of the first connecting rod (2) and, when said shooting angle (θ) is less than 0°, said first hinge (3′) of said rocker arm element (3) is pivoted only in the bend of the slot (20′) of the second connecting rod (2′).

### CROSS-REFERENCE TO RELATED APPLICATIONS

The present application claims priority from Italian Patent Application No. 102024000009889 filed May 2, 2024, the contents of which are incorporated herein by reference in its entirety.

### FIELD OF THE DISCLOSURE

The present invention concerns a load balancing device for heads for film and television shoots.

More precisely, the present invention concerns a mechanical device that allows the counterbalancing of the load of a filming device weighing on a support head for film or television shoots, for weights that vary considerably from one another depending on the type and size of the filming device and with a consistency of performance over the entire vertical panning arc, also called working arc.

### BACKGROUND OF THE DISCLOSURE

In the state of the art, said type of balancing device for cameras comprises one or more profiled elements, referred to as rocker arms or wings, which through one or more springs create a reaction force to the gravity acting on the filming device or the camera.

This reaction force, generated by an elastic element, is transmitted via a connecting rod to an eccentric body that acts as a crank, obtained on a side portion of the head adjacent to the vertical axis of rotation of the head itself at a fixed distance called eccentricity, thus allowing the balancing of the camera mounted on the balancing device. The connecting rod is pivoted on the eccentric portion and has the centre of rotation on said eccentric portion.

In order to obtain a consistent counterbalancing performance, the moment acting on the device due to the presence of the camera must be cancelled out by an opposing moment or “reacting” moment, which must be of a value equal and opposite to the moment acting throughout the working arc, equal to −90°-+90°, thereby compensating for the load caused by the variation of the position of the camera's centre of gravity for each different angle of use.

An example is described in the Italian patent no. IT 102004901246667 in the name of the same Applicant. This patent document describes a balancing device for a video camera head wherein a crank corresponding to the eccentric portion, a connecting rod and a rocker arm form, together with a frame element, a kinematic chain of three mobile elements of a Grashof articulated quadrilateral.

In this type of solution, the eccentric portion is pivoted in an eccentric position, at a fixed distance, referred to as eccentricity, from the axis of rotation of the camera head, thus having the centre of rotation in an eccentric position with respect to the camera's centre of rotation.

In this articulated quadrilateral, in case the camera is positioned at 0°, i.e. halfway through said working arc with respect to the axis of rotation of the balancing device, the eccentric portion aligns with the connecting rod, thereby representing a specific mechanism configuration called dead point configuration or also, as will be referred to from now on, singularity configuration.

With reference to FIGS. 2 and 3, it is possible to view, respectively, the graphical identification of the dead point configurations P for an articulated quadrilateral of the type mentioned above, and a graphical scheme of the possible arrangement of such dead points with respect to the working arc A of the camera.

As is known, the presence of a singularity configuration P in a mechanical device implies a lability in the vicinity of this configuration, which in the technical field of the invention is also the one most frequently operated.

In fact, the displacement of the head hinge of the connecting rod orthogonally to the axis of the connecting rod itself is a first-order infinitesimal, while the elongation of the connecting rod and of the rocker arm is a second-order infinitesimal, i.e. of a higher order than that of the head hinge of the connecting rod, thus resulting in a kinematic compatibility of the camera's motion in the vicinity of the dead point.

In other words, in correspondence with a singularity configuration P there may be micro-displacements that cause inaccuracies in the motion of the camera itself installed on said type of devices, such that the mechanism is functional, but is not very effective in the vicinity of the singularity configuration, leading to a significantly reduced image quality in shots that include a passage of the camera through this configuration.

### BRIEF DESCRIPTION OF THE DISCLOSURE

The aim of the present invention is to realise a load balancing device for heads for film and television shoots, capable of properly balancing said head even in singularity configurations, in particular always ensuring the correct univocity of motion and therefore a smooth and consistent operation throughout the working arc A ranging from −90° to +90° of the head's axis of rotation, thus improving the quality of the image/video obtained from the camera installed on the balancing device itself. The object of the present invention is a device for supporting and balancing the load of cameras for film and/or television shoots, said device comprising a main structure and a fixing plate for supporting the camera, said fixing plate being constrained in a centre of rotation on said main structure to perform a rotation with respect to a vertical axis of a shooting angle θ between −90° and +90°, said device further comprising
at least one first connecting rod element having a first end pivoted to said fixing plate at a first eccentric distance from said centre of rotation, a rocker arm element having a first hinge associated with the second end of said first connecting rod and a second hinge pivoted and coupled to said main structure,
at least one elastic element, pivoted at the top to said main structure and slidably coupled at the bottom to said rocker arm element,
said device being characterised in that it further comprises a second connecting rod having a first end pivoted to said fixing plate at a second eccentric distance from said centre of rotation and a second end associated with said first hinge of said rocker arm element, in that each connecting rod provides an oblong slot having at least one bend at its second end, in that said device is configured in such a way that when said shooting angle θ is equal to 0°, the eccentric distance O₁A₂ of the first connecting rod is oriented with respect to said vertical y axis by an offset angle φ greater than 0° and the eccentric distance O₁A₂′ of the second connecting rod is oriented with respect to said vertical y axis by an offset angle φ′ less than 0° and in such a way that the first hinge of said rocker arm element is pivoted in said bend of the oblong slot of each connecting rod, and
in that said device is configured in such a way that, when said shooting angle θ is greater than 0°, said first hinge of said rocker arm element is pivoted only in the bend of the slot of the first connecting rod and, when said shooting angle θ is less than 0°, said first hinge of said rocker arm element is pivoted only in the bend of the slot of the second connecting rod.

In particular, according to the invention, the axial width of the slot of each connecting rod measured along the axis between its ends can be at least equal to the length of the arc subtended between the two eccentric distances of the two connecting rods. Again, according to the invention, said axial width of the slot of each connecting rod can be equal to

aₙ≥2φₙ·eₙ

where
aₙ is equivalent to the axial width of the slot of a connecting rod,
φₙ is equivalent to the offset angle of the respective connecting rod, and
eₙ is equivalent to the eccentric distance of the respective connecting rod.

Furthermore according to the invention, the first eccentric distance of the first connecting rod and the second eccentric distance of the second connecting rod can have the same length.

Further according to the invention, the offset angle of the second connecting rod can be the negative of the offset angle of the first connecting rod.

In addition, according to the invention, the amplitude of the offset angle of each connecting rod can be less than or equal to 8.5°.

More specifically, according to the invention, the axial width of the slot of each connecting rod can be equivalent to:

aₙ<[AB−(R₁+R₂)]

where
aₙ is equivalent to the axial width of the slot of a connecting rod,
R₁ is the radius of the upper hinge of the respective connecting rod, and
R₂ is the radius of the bend of the oblong slot of the respective connecting rod.

Again, according to the invention, for each connecting rod the working angle, understood as the angle between the two dead point positions of the second end of each connecting rod can be equivalent to:

α≤90°.

In particular, according to the invention, the length of each connecting rod can be obtained from the following formula:

$$α = {cos}^{- 1} ( \frac{{\overline{{O}_{1} {B}^{II}}}^{2} + {( \overline{{O}_{1} {A}^{I}} + \overline{{A}^{I} {B}^{I}} )}^{2} - {\overline{{B}^{I} {B}^{II}}}^{2}}{2 \overline{{O}_{1} {B}^{II}} ( \overline{{O}_{1} {A}^{I}} + \overline{{A}^{I} {B}^{I}} )} )$$

where
O₁B″ is the distance between the centre of rotation of the fixing plate and the second end of the respective connecting rod in its second dead point position,
O₁A′ is the eccentric distance of the respective connecting rod,
A′B′ is the length of the respective connecting rod,
B′B″ is the distance between the two dead point positions of the second end of the respective connecting rod.

Furthermore according to the invention, said balancing device may further provide an eccentric body stably coupled to said fixing plate and comprising a first eccentric portion spaced from said centre of rotation by said first eccentric distance, and a second eccentric portion spaced from said centre of rotation by said second eccentric distance, wherein the first end of the first connecting rod is pivoted to said first eccentric portion and the second end of the second connecting rod is pivoted to said second eccentric portion.

Further according to the invention, said pair of connecting rods can be arranged at one side of said at least one elastic element with respect to a transverse axis passing through said centre of rotation and perpendicular to said vertical axis.

Again according to the invention, said balancing device can comprise two pairs of said connecting rods, wherein the second pair of connecting rods is arranged at the side of said at least one elastic element opposite the side on which the first pair of connecting rods is arranged with respect to said transverse axis, wherein said rocker arm element provides two first hinges arranged on the two opposite sides of said at least one elastic element along said transverse axis and wherein each pair of connecting rods has the second ends associated with a respective first hinge of the rocker arm element.

In addition, according to the invention, said balancing device can comprise at least two elastic elements adapted to be subjected to axial deformation along deformation axes parallel to each other.

In particular, according to the invention, two of said elastic elements may have concentric axes, and one may be inserted within the footprint of the other.

In addition, according to the invention, said first hinge of said balance element can be arranged in correspondence with a plane passing through said vertical axis. Again according to the invention, means can also be provided for adjusting the position of said at least one elastic element with respect to said rocker arm element. Further according to the invention, said rocker arm element can provide at least one track-shaped portion, wherein said at least one elastic element may have a protruding pin at its lower end adapted to slide on said track-shaped portion by the action of said adjustment means.

Finally, according to the invention, said adjustment means may be fastening means, in particular a screw, and control means, such as for example a knob, adapted to act on said fastening means acting on the lower end of the at least one elastic element.

### BRIEF DESCRIPTION OF THE DRAWINGS

The invention will now be described for illustrative but not limitative purposes, with particular reference to the drawings of the attached figures, wherein:

FIG. 1 shows a graphical scheme for calculating the potential energy of the mass of a head on which a camera, free to rotate around an axis of rotation at a fixed distance, is arranged;

FIG. 2 shows a graphical scheme for identifying the dead points of a balancing device based on the Grashof quadrilateral;

FIG. 3 shows a graphical scheme of a possible arrangement of the dead points with respect to the working arc A of a camera installed on a balancing device based on the kinematics of FIG. 2;

FIG. 4 shows the graphical scheme of FIG. 2 wherein the working triangle of the connecting rod of the balancing device is highlighted between the two identifiable singularity positions P;

FIG. 5 shows a perspective view of the balancing device according to the invention with an open structure, in a first embodiment;

FIG. 6 shows a perspective view of the balancing device according to the invention with a closed structure, in a second embodiment;

FIG. 7a shows a side view of the balancing device of FIG. 5;

FIG. 7b shows a sectional view along the VII-VII plane of the device of FIG. 7a;

FIG. 8a shows a bottom view of the device of FIG. 7a;

FIG. 8b shows a sectional view along the VIII-VIII plane of the device of FIG. 8a;

FIG. 9a shows a side view of the balancing device of FIG. 6;

FIG. 9b shows a side sectional view along a plane IX-IX of the device of FIG. 9a;

FIG. 10a shows a bottom view of the device of FIG. 9a;

FIG. 10b shows a sectional view along a plane X-X of the device of FIG. 10a;

FIG. 11a shows a side view of the balancing device according to the invention in a third embodiment;

FIG. 11b shows a side sectional view along a plane XI-XI of the device of FIG. 11a;

FIG. 12a shows a bottom view of the device of FIG. 11a;

FIG. 12b shows a sectional view along a plane XII-XII of the device of FIG. 12a;

FIG. 13 shows a partially cutaway perspective view of the balancing device of FIG. 6;

FIG. 14 shows a perspective view of the balancing device according to the invention, according to a fourth embodiment, partially cutaway to allow the slot-connecting rod coupling mechanism to be viewed;

FIG. 15 shows a side view of the two quadrilaterals of the crank-connecting rod-rocker arm-frame of the balancing device of FIG. 5;

FIGS. 16a-16c show a side view of the balancing device of FIG. 14, wherein it is possible to view the coupling phases of the two-slot-connecting rod coupling assembly, based on a first counter-balancing angle γ₁;

FIGS. 17a-17c show a side view of the balancing device of FIG. 14, wherein it is possible to view the coupling phases of the two-slot-connecting rod coupling assembly, based on a second counter-balancing angle γ₂; and

FIG. 18 shows a detail of FIG. 17a.

### DETAILED DESCRIPTION OF THE DISCLOSURE

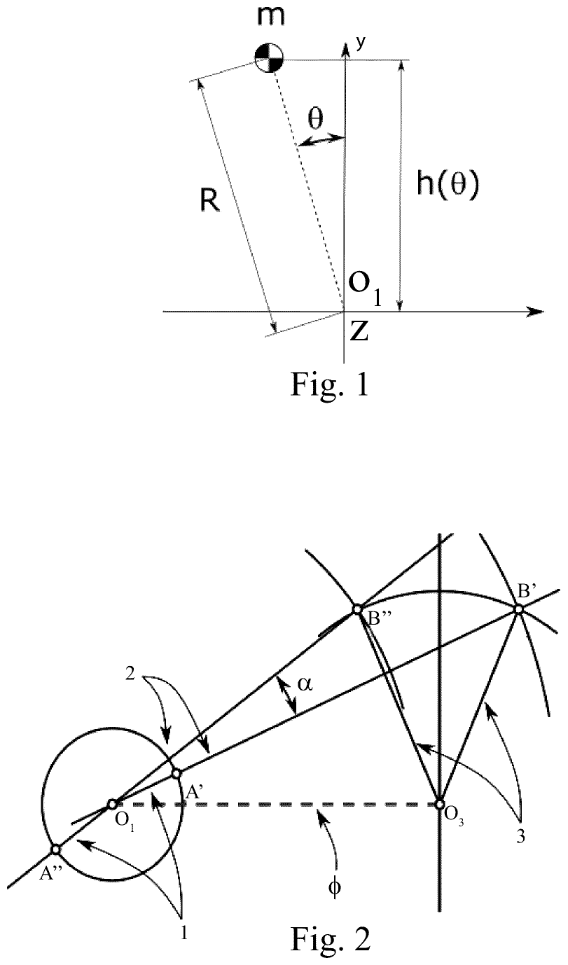

With reference to the graphical scheme of FIGS. 1-3 and as previously described, balancing systems for supporting a camera for shooting images or videos, based on the Grashof quadrilateral, are known in the state of the art. As described, this prior art balancing device provides one or more profiled elements, hereinafter referred to as wing, which through one or more springs create a reaction force to the gravity acting on the camera. This reaction force is transmitted through a connecting rod to an eccentric body on the vertical axis of rotation.

With reference to FIG. 2, the eccentric 1, the connecting rod 2 and the profiled element or wing 3 form the kinematic chain of the three mobile members of an articulated quadrilateral. In particular, the eccentric acts as a crank 1, while the wing is the rocker arm 3.

As previously stated, the reaction force generated by an elastic element is transmitted via the connecting rod 2 to the eccentric body 1 which acts as a crank, obtained on a side portion of the head adjacent to the axis of rotation O₁ of the head at a fixed distance called eccentricity e₂ coinciding with the segment O₁A (represented in the figure as O₁A′ or O₁A″ based on its position). Where the point O₁ in addition to representing the axis of rotation of the head, coincides with the axis of rotation of the crank 1 whose length is equal to the value of the eccentricity e₂, while the point A (represented in the figure as the points A′ and A″ based on its position) is the centre of rotation of the connecting rod 2.

From a theoretical point of view, according to the Grashof's classification of quadrilaterals, an articulated quadrilateral that meets the design constraints regarding the lengths of the mechanism's members to allow the proper closure, functionality and size must be of the crank-rocker arm class. Specifically, for each complete rotation of the crank, the rocker arm will reverse its motion twice and in correspondence with these reversals a singularity configuration will be obtained. For the balance between the potential energy of the camera's mass and the elastic energy of the elastic element, in particular of a spring, one of the two dead points, corresponding to the reversal of the rocker arm's motion, must necessarily be in correspondence with the horizontal position of the camera, in other words when the shooting angle θ, which is equivalent to the angle between the vertical y axis and the axis of the head t, is equal to 0° (see FIG. 1). In fact, instant by instant the energy balance is:

$$m g h = m g R ( 1 - cos θ ) = \frac{1}{2} k {x}^{2}$$

where, with reference to FIG. 1:
θ is the shooting angle, i.e. the angle between the shooting axis t and the vertical y axis,
m is the mass of the camera arranged on the shooting head,
g is the gravitational acceleration,
h is the current height of the camera's centre of gravity, which depends on θ, and is equivalent to the distance of the camera's centre of gravity from the plane on which the centre of rotation O₁ of the head lies,
R is the distance between the camera's centre of gravity and the rotation z axis or centre of rotation O₁,
k is the stiffness of the elastic element, and
x is the axial deformation, in particular the compression, of the elastic element.

From the previous relation it is evident that the potential energy of the camera is expressed as a function of the shooting angle θ and has a minimum precisely at θ=0°, therefore the elastic energy must also have a minimum at θ=0°.

In this position the axial deformation, in particular the compression, x of the spring element must be minimal, this condition can only be satisfied if θ=0° corresponds to a reversal point of the rocker arm's motion and therefore if at θ=0° there is a dead point of the articulated quadrilateral.

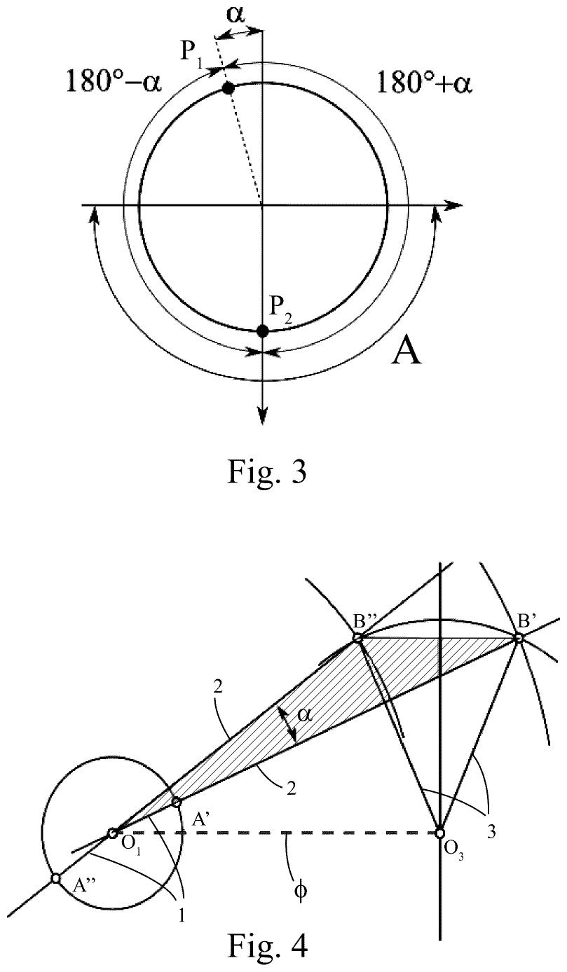

With reference to FIGS. 2 and 3, for an articulated quadrilateral of the crank 1-rocker arm 3 type, a dead point configuration P occurs approximately every 180°, therefore in a working arc A of 180° (from −90° to +90°) if one of the dead points P1 is at the centre of the arc (i.e. for θ=0°), there will be no other dead points in the same working arc A. In light of this, to overcome this issue it is sufficient to avoid the dead point configuration that occurs at θ=0°.

It is however necessary to specify that the angles between the two dead points P1 and P2 may not be exactly equal to each other and therefore of 180°, but may differ by a working angle α which depends on the geometry of the articulated quadrilateral itself, in any case this construction condition does not affect the effectiveness of the solution according to the invention.

The invention proposed to overcome the issues of the known art, provides that the balancing device 100 further comprises a second crank 1′, in particular a second eccentric body 1′ or a second eccentric portion 1′.

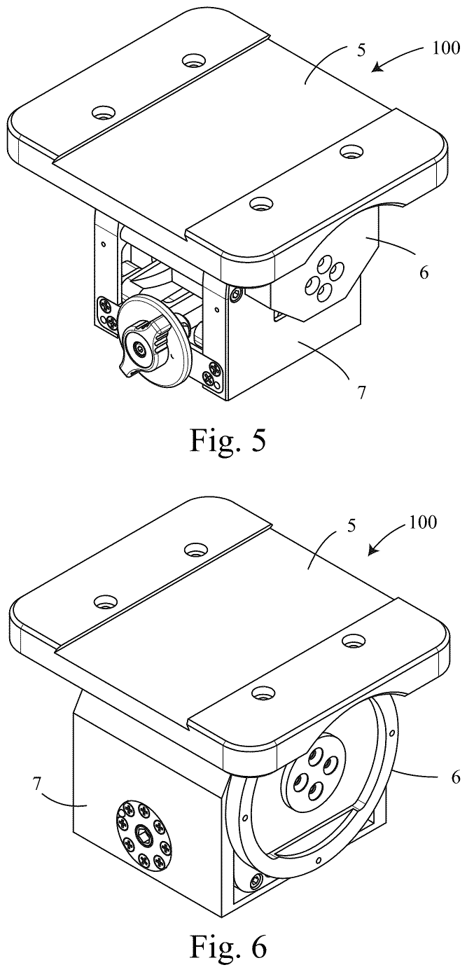

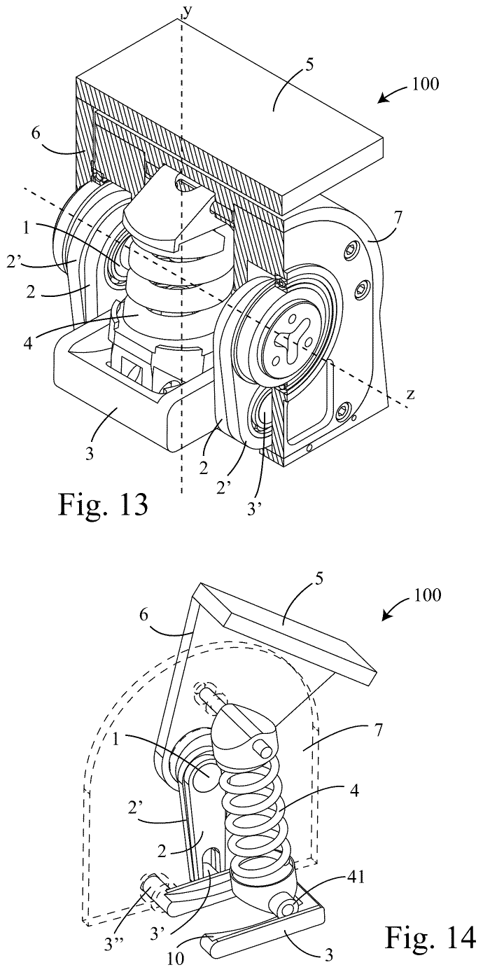

This balancing device 100 according to the invention is shown in various embodiments in FIGS. 5-18.

This second eccentric portion 1′ is also obtained on a side portion of the head or main structure 7 coupled to the fixing plate 5 for supporting the camera and is offset with respect to said first eccentric portion 1, in particular it is offset by a fixed angle, also referred to as offset angle φ. The second eccentric portion 1′ is also arranged at a fixed distance or eccentricity e₂′ from the centre of rotation O₁ of the fixing plate 5 which corresponds to its centre of rotation.

Consequently, the introduction of a second connecting rod 2′ is provided, which is pivoted on the rocker arm or wing 3 at the same point as the first connecting rod 2, in correspondence with a pin or first hinge 3′ of the rocker arm 3.

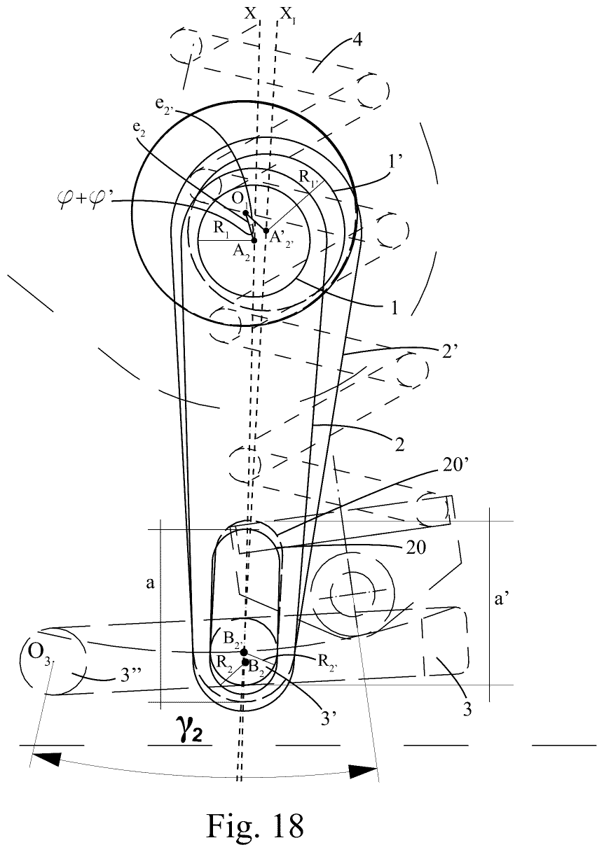

With reference to FIG. 18, it is possible to view the fixed distances e₂ and e_{2′} respectively, coinciding with the segments O₁A₂ and O₁A₂′, i.e. the two eccentricity values respectively associated with the connecting rods 2, 2′. Where the point O₁ represents the axis of rotation of the fixing plate 5 with respect to the structure of the head 7 which coincides with the axis of rotation of the two cranks 1, 1′ which have a length equal to the respective values of eccentricity e₂ and e_{2′}, while the points A₂ and Az′ are respectively the two centres of rotation of the two connecting rods 2 and 2′. In this way, two articulated quadrilaterals of the crank-connecting rod-rocker arm-frame type are effectively realised, with the eccentric portions 1, 1′ offset from each other and each pivoted eccentrically at the centre of rotation O₁ at a side portion of the head 7, each of which operates over half of the available working arc A, the first eccentric portion 1 between −90° and 0°, the second eccentric portion 1′ between 0° and +90°. The two quadrilaterals, appropriately sized, therefore operate together only on the working arc A in the configuration wherein the shooting angle θ is equivalent to 0°.

In the portion of the working arc A wherein one of the two articulated quadrilaterals is not operating, the respective connecting rod 2, 2′ is in fact decoupled from the pin or first hinge 3′ of the rocker arm 3 thanks to the presence of an oblong slot 20, 20′, having at least one bend, obtained at the foot or lower end or second end B₂, B₂′ of each connecting rod 2, 2′.

The balancing device 100 according to the invention is configured in such a way that when said shooting angle θ is equal to 0°, the eccentric distance O₁A₂ of the first connecting rod 2 is oriented with respect to said vertical y axis by an offset angle φ greater than 0° and the eccentric distance O₁A₂′ of the second connecting rod 2′ is oriented with respect to said vertical y axis by an offset angle φ′ less than 0° and in such a way that the first hinge 3′ of said rocker arm element 3 is pivoted in said bend of the oblong slot 20, 20′ of each connecting rod 2, 2′. Furthermore, said device is configured in such a way that when said shooting angle θ is greater than 0° said first hinge 3′ of said rocker arm element 3 is pivoted only in the bend of the slot 20 of the first connecting rod 2, and when said shooting angle θ is less than 0° said first hinge 3′ of said rocker arm element 3 is pivoted only in the bend of the slot 20′ of the second connecting rod 2′.

Thanks to this solution, neither of the two articulated quadrilaterals will operate in a singularity configuration when under load, always ensuring the correct univocity of the motion and therefore a smooth and consistent operation throughout the entire working arc A, from −90° to +90°.

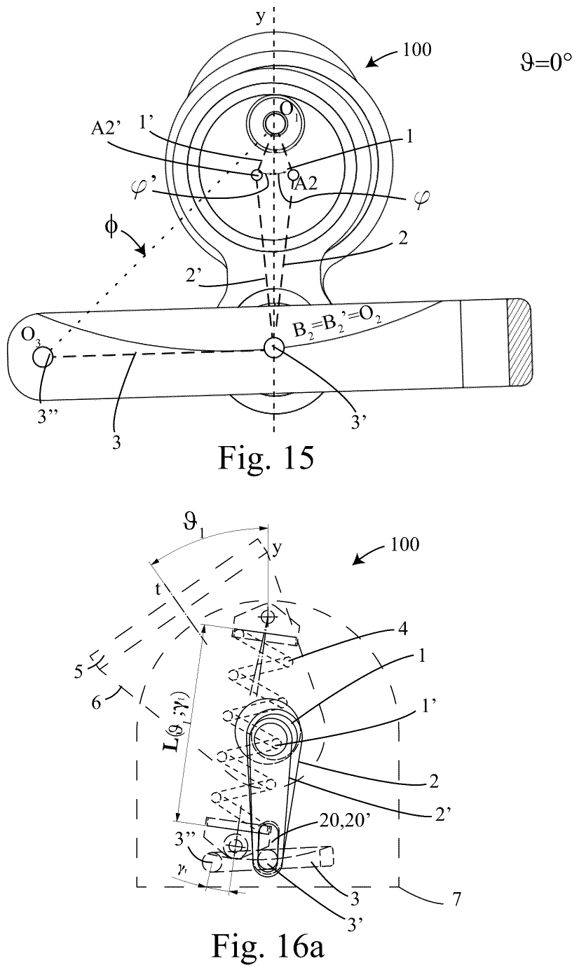

With reference to FIG. 15, the length of the two cranks 1, 1′, which corresponds to the eccentricity value of each crank 1, 1′, in the embodiments described is preferably the same, while the offset between the two eccentric portions 1, 1′ is the offset between the connecting rods 2, 2′ themselves of the two articulated quadrilaterals, wherein the rocker arm or wing 3 is the common element to both the articulated quadrilaterals.

In the balancing device 100 according to the invention, the reaction force is generated by at least one elastic element 4, in particular comprising one or more springs 4, which is transmitted to the profiled element or wing 3, which in turn transmits this reaction force via at least one of said connecting rods 2, 2′ to the eccentric portions 1, 1′, which then receives a reaction moment that balances the overturning moment caused by gravity on the camera.

In the embodiments described herein, the elastic element is preferably of the type adapted to undergo axial deformations and can be one or more springs 4, in particular of the helical type. However, in other embodiments the elastic element can be a hydraulic piston, an elastomer, for example made of synthetic material. In other words, the elastic element must be able to return an equal and opposite elastic force based on the displacement performed.

This balancing device 100 has, at an upper portion thereof, a fixing plate 5 of the head 7 to fix a camera, said camera will rotate on the central z axis of rotation with respect to the centre of rotation O₁. The eccentric portions 1, 1′ are integral with said fixing plate 5 and connected via any adapters 6.

Said rocker arm 3 is coupled both to an end portion of each of said connecting rods 2, 2′, via said first hinge 3′ in correspondence with said slots 20, 20′, and at its other end, it is pivoted to the main structure of the head 7, via a second hinge 3″. The main structure of the head 7 can be realised as either a closed or open structure. The choice of realising the balancing device 100 with a closed or open structure is evaluated on a case-by-case basis through a cost/benefit analysis. In fact, the closed structure is structurally more efficient compared to the open one, but it is more expensive to make and heavier than the latter.

Furthermore, the balancing device 100 according to the invention has fastening means 8, in particular a screw 8, operated by control means 9, such as for example a knob 9, which allow a user to move the lower end of the at least one elastic element 4 on a track 10 obtained in the rocker arm 3, thus allowing the application point of the reaction force generated by said at least one elastic element 4 to be varied with respect to the fulcrum of the rocker arm 3 itself. Said track 10, shown in FIG. 14, is substantially a shaped portion of the rocker arm 3 on which the lower support 41 of the elastic element 4 slides.

This allows the reaction moment generated on the cranks 1, 1′, to be advantageously varied, so that it can be easily and quickly adapted by an operator to cameras of different weights.

The rocker arm 3 can be moved by at least one pair of connecting rods 2, 2′ at one of its sides and operate in a cantilevered configuration or alternatively it can be connected to two pairs of connecting rods 2, 2′ arranged one on each side of said rocker arm 3 via two respective first pins 3′.

According to the invention, the offset angle φ of each eccentric portion 1, 1′, is preferably optimised to achieve the best response of the balancing device 100 on the camera around the shooting angle θ on the working arc A equal to 0°, preferably the offset angle φ should not exceed 8.5°, in order to avoid undesirable balancing errors at the ends of the working arc A of the camera.

With reference to FIG. 15, it is shown how said offset angle φ (for θ=0°) is between the segment O₁A₂′ and the vertical y axis for the second eccentric portion 1′ and is similarly between the segment O₁A₂ and the vertical y axis for the first eccentric portion 1.

In fact, the said offset angle φ between the eccentric portions 1, 1′ introduces an undesired effect of anticipating the maximum of the reaction moment by an angle equal to the offset angle φ.

In fact, the maximum of the reaction moment should be at the ends of the working arc A (therefore at ±90°), wherein a small displacement of the maximum towards the centre of the working arc A is still acceptable, by virtue of the non-linearity of the trigonometric relationship that links the rotation of the camera and the variation of the arm with respect to the centre of gravity.

In order to avoid jamming caused by the overlap of the two offset mutually articulated quadrilaterals, a respective slot 20, 20′ is in fact provided at the foot of each connecting rod 2, 2′ which allows the decoupling between the respective connecting rod 2, 2′ itself and said second hinge 3′ of said rocker arm 3 beyond a specific structurally fixed working angle α, in particular 90°. When the camera rotates on the balancing device 100, the shooting angle θ inverts its sign (i.e. it goes from positive to negative values and vice versa) and consequently a first connecting rod 2 will operate for values of θ between 0 and +90°, while the second connecting rod 2′ will operate for values of θ between −90° and 0 thanks to the presence of the two slots 20, 20′ of each connecting rod 2, 2′.

Thanks to the correct sizing of each slot 20, 20′ it is possible to guarantee the kinematic accuracy of the kinematics of the balancing device 100 according to the invention, wherein preferably each slot 20, 20′ has an axial extension a, a′, measured along a respective longitudinal x, x′ axis defined respectively by the segments A₂B₂ for the first connecting rod 2 and A₂B₂ for the second connecting rod 2′, at least equal to the length of the arc subtended between the two eccentric portions 1, 1′.

This relationship can be expressed with the following formula:

a≥2φ·e

where:
a is the axial extension of each slot 20, 20′,
e is the value of the eccentricity, which corresponds to the length of the respective eccentric portion 1, 1′,
φ is the offset angle of each eccentric portion 1, 1′.

It is necessary to specify that this represents a minimum condition to avoid the interference between said two articulated quadrilaterals of the balancing device 100 according to the invention, and it has been assumed that the two eccentric portions 1, 1′ have the same values of eccentricity e and offset angle φ, a condition which is however not strictly necessary.

The maximum value of each of said axial extensions a, a′ of each slot 20, 20′ depends on the size of the respective connecting rods 2, 2′ and of the respective hinges 3′ of the rocker arm 3. For the first connecting rod 2, this value of axial length a is equivalent to:

a<[A2B2−(R1+R2)

where R₁ is the radius of the upper hinge A₂ of the first connecting rod 2, and R₂ is the radius of the lower hinge B₂ of the first connecting rod 2.

Similarly for the second connecting rod 2′ the value of the axial length a′ is equivalent to:

a′<[A2′B2′−(R1′+R2′)

where R₁′ is the radius of the upper hinge A₂′ of the second connecting rod 2′, and R₂′ is the radius of the lower hinge B₂′ of the second connecting rod 2′.

For the technical solution according to the invention to be effective, preferably the working angle α is equivalent to:

α≤90°

in order to ensure that each of the two articulated quadrilaterals, when under load during use, is not in a dead point configuration.

With reference to FIG. 4, this condition is satisfied by properly sizing the length of the members of each articulated quadrilateral, specifically the ratio between the lengths of the frame and the rocker arm 3. In light of this, the relationship that links said working angle α to the other dimensional quantities of each articulated quadrilateral can be obtained by applying the cosine theorem to the triangle O₁B′B″:

$$α = {cos}^{- 1} ( \frac{{\overline{{O}_{1} {B}^{II}}}^{2} + {( \overline{{O}_{1} {A}^{I}} + \overline{{A}^{I} {B}^{I}} )}^{2} - {\overline{{B}^{I} {B}^{II}}}^{2}}{2 \overline{{O}_{1} {B}^{II}} ( \overline{{O}_{1} {A}^{I}} + \overline{{A}^{I} {B}^{I}} )} )$$

Thanks to these dimensional measures of the slots 20, 20′ and of the working angle α, the balancing device 100 advantageously ensures that, in the working condition equal to 0° on the working arc A, it never operates in singularity conditions. In fact, the presence of a second articulated quadrilateral, in particular thanks to the two connecting rods 2, 2′ and to the respective slots 20, 20′, allows the passage of the camera through the working point equal to 0° to be smooth.

This is possible because the camera is controlled, within the range −α≤0≤+α of the horizontal working angle equal to 0°, by both the articulated quadrilaterals thanks to the respective eccentricities of the eccentric portions 1, 1′.

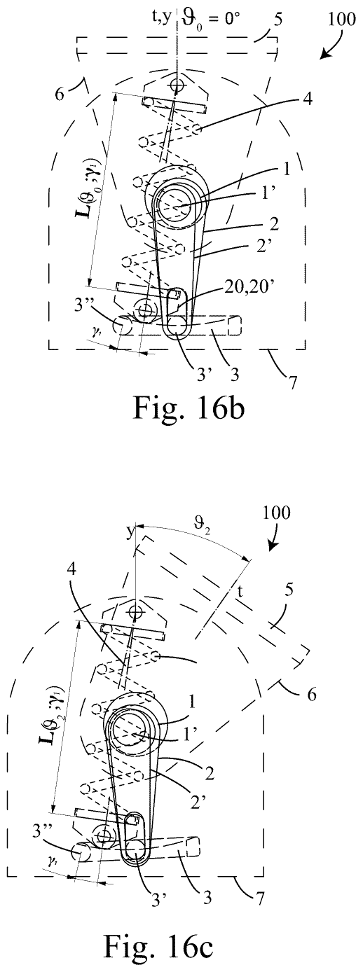

These aforementioned passages can be seen in FIGS. 16a-16c, which show two levels of counterbalancing, both dependent on the shooting angle θ. In fact, based on the shooting angle θ the system is represented in three different positions, so as to highlight the slots 20, 20′ of the respective connecting rods 2, 2′, wherein:
for θ=0° both connecting rods 2, 2′ engage the rocker arm 3 (FIG. 16b);
for θ=91 only the second connecting rod 2′ of the second articulated quadrilateral engages the rocker arm 3, while the first connecting rod 2 of the first articulated quadrilateral is not engaged (FIG. 16a);
for θ=θ₂ vice versa only the first connecting rod 2 of the first articulated quadrilateral engages the rocker arm 3, while the second connecting rod 2′ of the second articulated quadrilateral is not engaged (FIG. 16c).

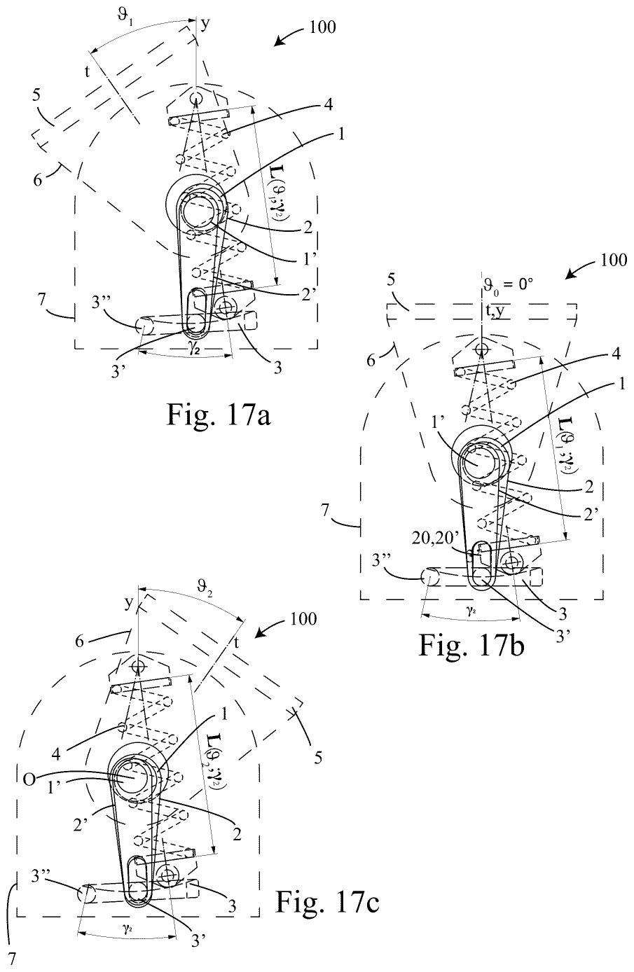

In FIGS. 17a-17b the same three positions of the connecting rods 2, 2′ are shown with a different level of counterbalancing defined by the counterbalancing angle γ equal to γ₂ greater than the counterbalancing angle γ₁ of FIGS. 16a-16c.

The balancing device 100 according to the invention provides multiple embodiments, in particular with reference to the realisation of the at least one elastic element 4 and to the number of pairs of connecting rods 2, 2′.

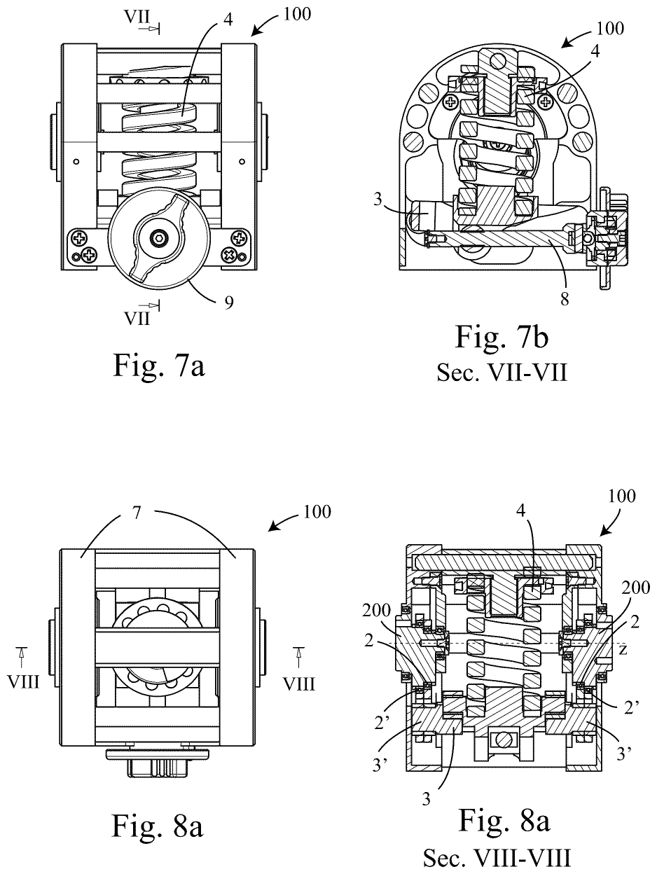

In a first embodiment, visible in FIGS. 7a-8b, the balancing device 100 according to the invention provides a single elastic element 4, in particular a single spring 4, and two pairs of connecting rods 2, 2′, each pair being coupled to each side of the rocker arm 3 via a respective second hinge 3′. This configuration of the balancing device 100 allows the rocker arm 3 to be loaded symmetrically, thus avoiding being subjected to torsion loading as occurs in the cantilevered configuration of the third and fourth embodiments. The cantilevered configuration implies an ad hoc sizing to resist this type of load.

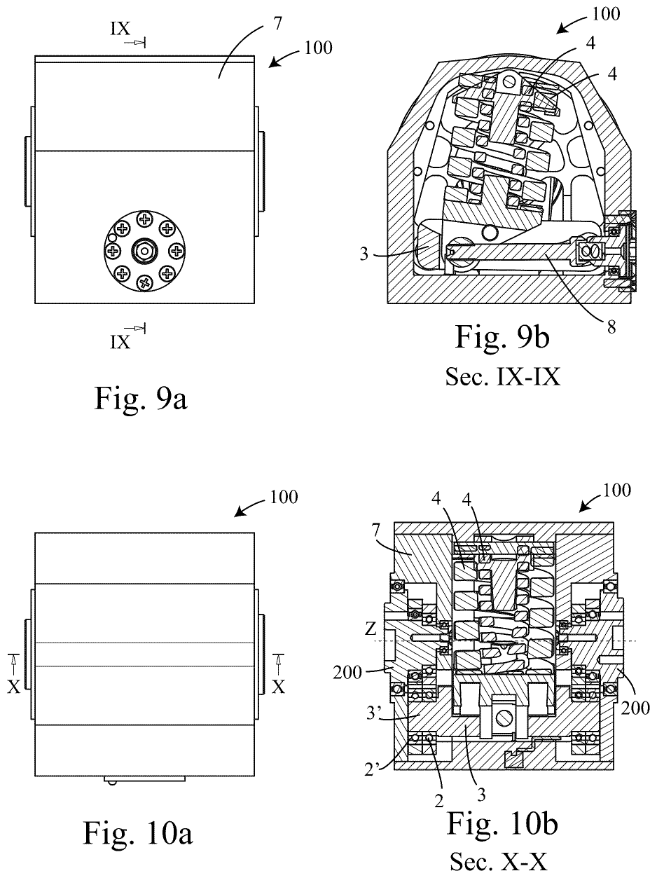

On the other hand, the symmetrical configuration increases the cost and weight of the balancing device 100 itself since two pairs of connecting rods 2, 2′ are used. In a second embodiment, visible in FIGS. 9a-10b and 13, the balancing device 100 according to the invention, unlike the previous embodiment, provides two elastic elements 4, in particular two concentric springs 4, one inserted within the footprint of the other, thus forming a single double-spiral spring element 4. The use of one or more springs 4 in parallel, in particular one inserted within the other, makes it possible to increase the stiffness k of the resulting spring and at the same time to optimise the space. Furthermore, as in the previous embodiment, the use of two pairs of connecting rods 2, 2′ is provided.

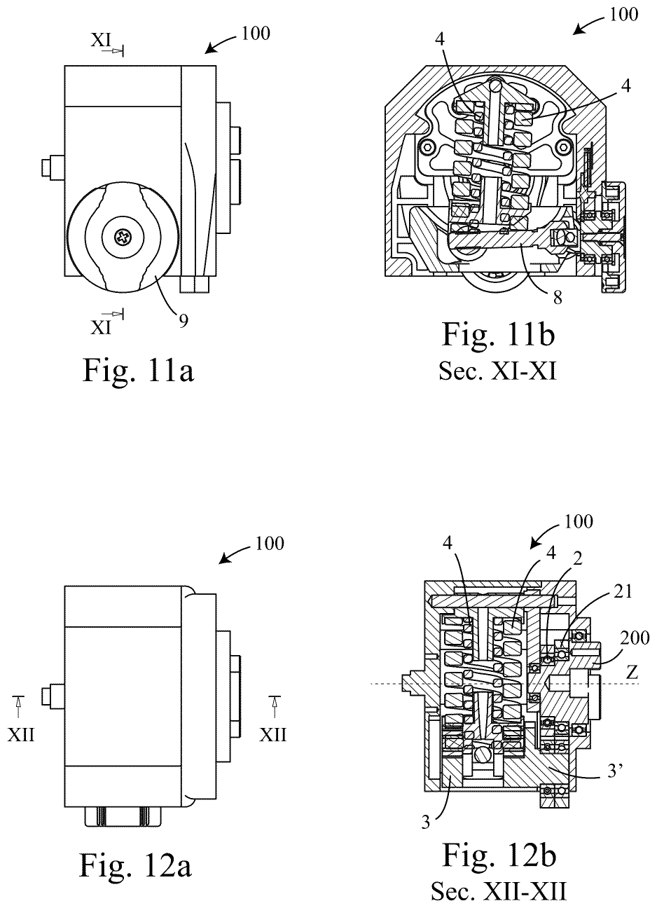

Finally, in a third embodiment, visible in FIGS. 11a-12b, the balancing device 100 according to the invention provides said double-spiral spring element 4, as in the previous embodiments, but only one pair of connecting rods 2, 2′, each coupled to one side of the rocker arm 3.

With particular reference to FIG. 14, it can be seen how the rocker arm 3, in said fourth embodiment, hinged only at said second hinge 3′ to the pair of connecting rods 2, 2′, will operate in a cantilevered manner, in fact the rocker arm 3 will be subjected to an asymmetric load, being hinged to the connecting rods 2, 2′ only on one side.

With particular reference to FIG. 12b, it can be observed that, also in the third embodiment, a cantilevered configuration is shown wherein the rocker arm 3 operates with a fulcrum in correspondence with its pin 3′ and a load that can be schematised as directed along the main axis of the springs 4.

In the foregoing, the preferred embodiments have been described and some variants of the present invention have been suggested, but it is to be understood that those skilled in the art may make modifications and changes without thereby departing from the relative scope of protection, as defined by the attached claims.

1. A device for supporting and balancing the load of cameras for film and/or television shoots, said device comprising a main structure and a fixing plate for supporting the camera, said fixing plate being constrained in a centre of rotation on said main structure to perform a rotation with respect to a vertical axis of a shooting angle between −90° and +90°, said device further comprising
at least one first connecting rod element having a first end pivoted to said fixing plate at a first eccentric distance from said centre of rotation,
a rocker arm element having a first hinge associated with the second end of said first connecting rod and a second hinge pivoted and coupled to said main structure,
at least one elastic element, pivoted at the top to said main structure and slidably coupled at the bottom to said rocker arm element,
said device being characterised in that it further comprises a second connecting rod having a first end pivoted to said fixing plate at a second eccentric distance from said centre of rotation and a second end associated with said first hinge of said rocker arm element,
in that each connecting rod provides an oblong slot having at least one bend at its second end,
in that said device is configured in such a way that when said shooting angle is equal to 0°, the eccentric distance of the first connecting rod is oriented with respect to said vertical axis by an offset angle greater than 0° and the eccentric distance of the second connecting rod is oriented with respect to said vertical axis by an offset angle less than 0°, and in such a way that the first hinge of said rocker arm element is pivoted in said bend of the oblong slot of each connecting rod, and
in that said device is configured in such a way that, when said shooting angle is greater than 0°, said first hinge of said rocker arm element is pivoted only in the bend of the slot of the first connecting rod and, when said shooting angle is less than 0°, said first hinge of said rocker arm element is pivoted only in the bend of the slot of the second connecting rod.

2. The device according to claim 1, wherein the axial width of the slot of each connecting rod measured along the axis between its ends is at least equal to the length of the arc subtended between the two eccentric distances of the two connecting rods.

3. The device according to claim 2 wherein said axial width of the slot of each connecting rod is equal to
aₙ≥2φₙ·eₙ
where
aₙ is equivalent to the axial width of the slot of a connecting rod,
φₙ is equivalent to the offset angle of the respective connecting rod, and
eₙ is equivalent to the eccentric distance of the respective connecting rod.

4. The device according to claim 1, wherein the first eccentric distance of the first connecting rod and the second eccentric distance of the second connecting rod have the same length.

5. The device according to claim 1, wherein the offset angle of the second connecting rod is the negative of the offset angle of the first connecting rod.

6. The device according to claim 1, wherein the amplitude of the offset angle of each connecting rod is less than or equal to 8.5°.

7. The device according to claim 1, wherein the axial width of the slot of each connecting rod is equivalent to:
aₙ<[AB−(R₁+R₂)]
where
aₙ is equivalent to the axial width of the slot of a connecting rod,
R₁ is the radius of the upper hinge of the respective connecting rod, and
R₂ is the radius of the bend of the oblong slot of the respective connecting rod.

8. The device according to claim 1, wherein for each connecting rod the working angle, understood as the angle between the two dead point positions of the second end of each connecting rod is equivalent to:
α≤90°.

9. The device according to claim 8, wherein the length of each connecting rod can be obtained from the following formula:
$$α = {cos}^{- 1} ( \frac{{\overline{{O}_{1} {B}^{II}}}^{2} + {( \overline{{O}_{1} {A}^{I}} + \overline{{A}^{I} {B}^{I}} )}^{2} - {\overline{{B}^{I} {B}^{II}}}^{2}}{2 \overline{{O}_{1} {B}^{II}} ( \overline{{O}_{1} {A}^{I}} + \overline{{A}^{I} {B}^{I}} )} )$$
where
O₁B″ is the distance between the centre of rotation of the fixing plate and the second end of the respective connecting rod in its second dead point position,
O₁A′ is the eccentric distance of the respective connecting rod,
A′B′ is the length of the respective connecting rod,
B′B″ is the distance between the two dead point positions of the second end of the respective connecting rod.

10. The device according to claim 1, wherein it further provides an eccentric body stably coupled to said fixing plate and comprising a first eccentric portion spaced from said centre of rotation by said first eccentric distance, and a second eccentric portion spaced from said centre of rotation by said second eccentric distance, wherein the first end of the first connecting rod is pivoted to said first eccentric portion and the second end of the second connecting rod is pivoted to said second eccentric portion.

11. The device according to claim 1, wherein said pair of connecting rods is arranged at one side of said at least one elastic element with respect to a transverse axis passing through said centre of rotation and perpendicular to said vertical axis.

12. The device according to claim 11, wherein it comprises two pairs of said connecting rods, wherein the second pair of connecting rods is arranged at the side of said at least one elastic element opposite the side on which the first pair of connecting rods is arranged with respect to said transverse axis, wherein said rocker arm element provides two first hinges arranged on the two opposite sides of said at least one elastic element along said transverse axis and wherein each pair of connecting rods has the second ends associated with a respective first hinge of the rocker arm element.

13. The device according to claim 1, wherein it comprises at least two elastic elements adapted to be subjected to axial deformation along deformation axes parallel to each other.

14. The device according to claim 13, wherein it comprises two of said elastic elements which have concentric axes, and one inserted within the footprint of the other.

15. The device according to claim 1, wherein said first hinge of said rocker arm element is arranged in correspondence with a plane passing through said vertical axis.

16. The device according to claim 1, wherein means are also provided for adjusting the position of said at least one elastic element with respect to said rocker arm element.

17. The device according to claim 16, wherein said rocker arm element provides at least one track-shaped portion, wherein said at least one elastic element has a protruding pin at its lower end adapted to slide on said track-shaped portion by the action of said adjustment means.

18. The device according to claim 16, wherein said adjustment means are fastening means, in particular a screw, and control means, such as for example a knob, adapted to act on said fastening means acting on the lower end of the at least one elastic element.
